(19) United States
(12) Patent Application Publication
(10) Pub. No.: US 2018/0138754 A1
(43) Pub. Date: May 17, 2018

(54) WIRELESS COMMUNICATION DEVICE AND METHOD FOR RF ENERGY HARVESTING

(71) Applicant: HUAWEI TECHNOLOGIES CO., LTD., Shenzhen (CN)

(72) Inventors: Afef FEKI, Munich (DE); Kamel TOURKI, Boulogne Billancourt (FR); Moez DRAIEF, Boulogne Billancourt (FR); Beatrice TOMASI, Boulogne Billancourt (FR)

(21) Appl. No.: 15/869,462

(22) Filed: Jan. 12, 2018

Related U.S. Application Data
(63) Continuation of application No. PCT/EP2015/067663, filed on Jul. 31, 2015.

(51) Int. Cl. H02J 50/20; H02J 50/80; H02J 7/02; H04B 5/00; H04W 52/02

(52) U.S. Cl. CPC H02J 50/20; H02J 50/80; H04W 52/0296; H04B 5/0037; H04W 52/0229; H02J 7/025

(57) ABSTRACT

The present disclosure relates to a wireless communication device and method. The example wireless communication device is configured to communicate with an energy distributor, where the wireless communication device includes a rechargeable energy storage configured to supply the wireless communication device with energy to maintain operation of the wireless communication device. The device also includes a transmitter configured to transmit an energy status message to the energy distributor. The device further includes a receiver configured to extract energy from a wireless signal received by the wireless communication device from an energy provider, the wireless signal received in response to the energy status message transmitted to the energy distributor. The receiver can then recharge the rechargeable energy storage using the energy extracted from the wireless signal.

### CROSS-REFERENCE TO RELATED APPLICATIONS

This application is a continuation of International Application No. PCT/EP2015/067663, filed on Jul. 31, 2015, which is hereby incorporated by reference in its entireties.

### TECHNICAL FIELD

The present invention relates to a wireless communication device and method. In particular, the present invention relates to a wireless communication device and method allowing for RF energy harvesting.

### BACKGROUND

The interest in energy efficiency of communication networks has been rekindled in the last decade with the growing concern about global warming and the increasing proportion of the information and communication technologies (ICT) within the global carbon footprint. The world's ICT ecosystem uses about 1500 TWh of electricity annually, equal to all the electric generation of Japan and Germany combined. ICT is predicted to increase its energy consumption every year, as it increasingly penetrates all areas of human activity through new technologies such as cloud computing, mobile internet, internet of things, and new devices such as smart phones, tablets and smart watches. To reduce the carbon footprint of ICT, increasing the energy efficiency in acquisition, processing and distribution of information over wired and wireless networks, has become a major challenge for researchers. Communication systems already take up some 25% of the energy used by ICT. Therefore, it is of utmost importance that both wired and wireless communication devices are designed for optimal energy efficiency, without sacrificing quality of service or performance.

Recently energy harvesting (EH) has emerged as a powerful complementary technology for wireless networks to extend the lifetime of the network and to reduce the dependence on the power-grid and battery. Mechanical energy, electrical or magnetic fields, light, or temperature differences in the environment can be harvested by converting them into energy for powering sensors using piezoelectric, radio frequency, thermoelectric, inductive coupling, wind, or solar harvesting technologies.

In today's connected world, where wireless networks are ubiquitous, ambient radio frequency (RF) energy is everywhere, presenting itself as a potential energy source for energy-constrained wireless networks. There are several advantages of RF energy harvesting compared to other potential sources of ambient energy: i) it can be harvested using the existing antennas of the nodes, ii) RF energy can be intentionally transmitted from remote charging stations, and hence, the receivers are less dependent on the randomness of the environment for their operation, such as solar energy harvesters not functioning during night.

Some solutions for optimizing the battery usage in a wireless communication device are known. US2012/0210325, for instance, discloses a wireless communication device including a smart task scheduler for extending the lifetime of the battery of the wireless communication device. This approach, however, allows only a limited optimization and once the battery of the wireless communication device is empty, the device is “out of service”.

US2013/0106352 discloses a USB battery charger allowing to recharge a wireless communication device whenever needed, i.e., opportunistically. However, such a US battery charger also needs to be recharged beforehand.

Thus, there is a need for an improved wireless communication device and method, in particular an improved wireless communication device and method suitable allowing for RF energy harvesting.

### SUMMARY

It is an objective of the invention to provide an improved wireless communication device and method, in particular an improved wireless communication device and method suitable for RF energy harvesting.

This objective is achieved by the subject matter of the independent claims. Further implementation forms are provided in the dependent claims, the description and the figures.

According to a first aspect the invention relates to a wireless communication device configured to communicate with an energy distributor, in particular a base station or a further wireless communication device, the wireless communication device comprising: a rechargeable energy storage configured to supply the wireless communication device with energy to maintain operation of the wireless communication device; a transmitter configured to transmit to the energy distributor an energy status message; and a receiver configured to extract energy from a wireless signal received by the wireless communication device from an energy provider and to use the energy extracted from the wireless signal to recharge the rechargeable energy storage, wherein the wireless signal is provided by the energy provider in response to the energy status message transmitted to the energy distributor.

Thus, an improved wireless communication device allowing for RF energy harvesting is provided.

In a first possible implementation form of the first aspect of the invention as such the wireless communication device further comprises a predictor configured to predict the amount of energy required to maintain operation of the wireless communication device until the end of an upcoming time window based on the current level of the rechargeable energy storage and an energy consumption profile of the wireless communication device.

In a second possible implementation form of the first aspect of the invention as such or the first implementation form thereof the energy status message comprises information about the amount of energy required to maintain operation of the wireless communication device until the end of the upcoming time window and/or information about a time interval defining by when the amount of energy required to maintain operation of the wireless communication device has to be received by the wireless communication device.

In a third possible implementation form of the first or second implementation form of the first aspect of the invention the wireless communication device further comprises a profiler configured to generate the energy consumption profile of the wireless communication device.

In a fourth possible implementation form of the third implementation form of the first aspect of the invention the wireless communication device is configured to perform a plurality of processes and the profiler is configured to generate the energy consumption profile of the wireless communication device on the basis of the frequency, the duration and/or the time correlation of the processes of the plurality of processes performed by the wireless communication device within an elapsed time window.

In a fifth possible implementation form of the first to fourth implementation form of the first aspect of the invention the wireless communication device is configured to perform a plurality of processes, wherein the wireless communication device further comprises a scheduler for scheduling processes of the plurality of processes in the upcoming time window, wherein the predictor is configured to predict the amount of energy required to maintain operation of the wireless communication device until the end of the upcoming time window based on the current level of the rechargeable energy storage, the energy consumption profile of the wireless communication device and the scheduled processes in the upcoming time window.

In a sixth possible implementation form of any one of the first to fifth implementation form of the first aspect of the invention the predictor is further configured to predict the end of the upcoming time window on the basis of at least one recharging event within an elapsed time window. In other words, the predictor is configured to take into account past recharging events in order to estimate whether such a recharging is likely to happen before the end of the upcoming time window.

In a seventh possible implementation form of the first aspect of the invention as such or any one of the first to sixth implementation form thereof the transmitter is configured to transmit the energy status message as part of a data message to the energy distributor, i.e. as part of a message containing control data and/or payload data to be provided to the energy distributor.

In an eighth possible implementation form of the first aspect of the invention as such or any one of the first to seventh implementation form thereof the wireless communication device is further configured to perform an energy consuming process involving a further wireless communication device in return for energy provided by the energy provider.

In a ninth possible implementation form of the first aspect of the invention as such or any one of the first to eighth implementation form thereof the energy status message comprises information about the current level of the rechargeable energy storage of the wireless communication device, the level of the rechargeable energy storage of the wireless communication device at the end of an upcoming time window, the storage capacity of the rechargeable energy storage of the wireless communication device and/or a minimum storage level of the rechargeable energy storage required to operate the wireless communication device.

According to a second aspect the invention relates to an energy distributor, in particular a base station or a wireless communication device, configured to communicate with a further wireless communication device, the energy distributor comprising a receiver configured to receive from the further wireless communication device an energy status message, wherein the energy distributor is further configured to cause an energy provider to provide energy to the further wireless communication device by means of a wireless signal in response to the energy status message.

In a first possible implementation form of the second aspect of the invention as such the energy status message comprises information about the current level of a rechargeable energy storage of the further wireless communication device, wherein the energy distributor further comprises a predictor configured to predict the amount of energy required to maintain operation of the further wireless communication device until the end of an upcoming time window based on the current level of the rechargeable energy storage and an energy consumption profile of the further wireless communication device.

In a second possible implementation form of the second aspect of the invention as such or the first implementation form thereof the energy provider is a transmitter of the energy distributor, wherein the transmitter of the energy distributor is configured to provide energy to the further wireless communication device by means of a wireless signal.

According to a third aspect the invention relates to a method of operating a wireless communication device configured to communicate with an energy distributor, in particular a base station or a further wireless communication device, comprising the steps of supplying the wireless communication device with energy from a rechargeable energy storage of the wireless communication device to maintain operation of the wireless communication device, transmitting to the energy distributor an energy status message, and extracting energy from a wireless signal received by the wireless communication device from an energy provider and using the energy extracted from the wireless signal to recharge the rechargeable energy storage, wherein the wireless signal is provided by the energy provider in response to the energy status message transmitted to the energy distributor.

The method according to the third aspect of the invention can be performed by the wireless communication device according to the first aspect of the invention. Further features of the method according to the third aspect of the invention result directly from the functionality of the wireless communication device according to the first aspect of the invention and its different implementation forms described above.

According to a fourth aspect the invention relates to a computer program comprising program code for performing the method according to the third aspect of the invention when executed on a computer.

The invention can be implemented in hardware and/or software.

### BRIEF DESCRIPTION OF THE DRAWINGS

Further embodiments of the invention will be described with respect to the following figures, in which:

FIG. 1 shows a schematic diagram of a wireless communication network comprising several wireless communication devices according to an embodiment and an energy distributor according to an embodiment;

FIG. 2 shows a schematic diagram of a wireless communication device according to an embodiment;

FIG. 3 shows a schematic diagram of a method of operating a wireless communication device according to an embodiment;

FIG. 4 shows a flow chart illustrating the operation of a wireless communication device according to an embodiment;

FIG. 5 shows a flow chart illustrating the operation of a wireless communication device according to an embodiment;

FIG. 6 shows a flow chart illustrating the operation of an energy distributor in form of a base station according to an embodiment;

FIG. 7 shows a signaling diagram illustrating the signaling between a wireless communication device, an energy distributor in form of a base station and an energy provider according to an embodiment; and

FIG. 8 shows a signaling diagram illustrating the signaling between a wireless communication device, an energy distributor in form of a base station and an energy provider according to an embodiment.

### DETAILED DESCRIPTION OF EMBODIMENTS

In the following detailed description, reference is made to the accompanying drawings, which form a part of the disclosure, and in which are shown, by way of illustration, specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

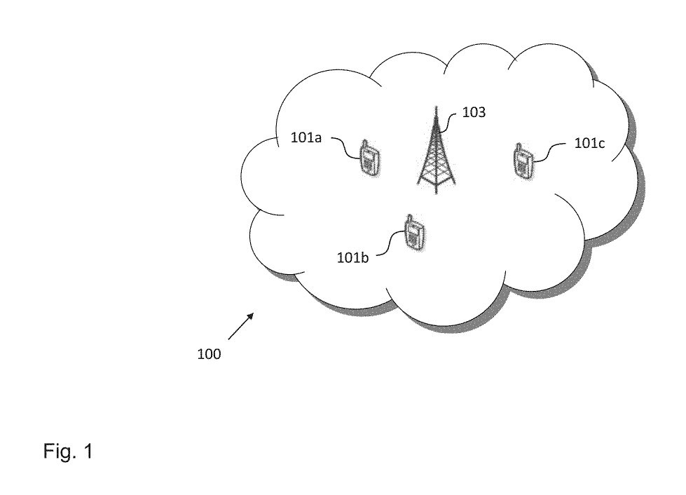

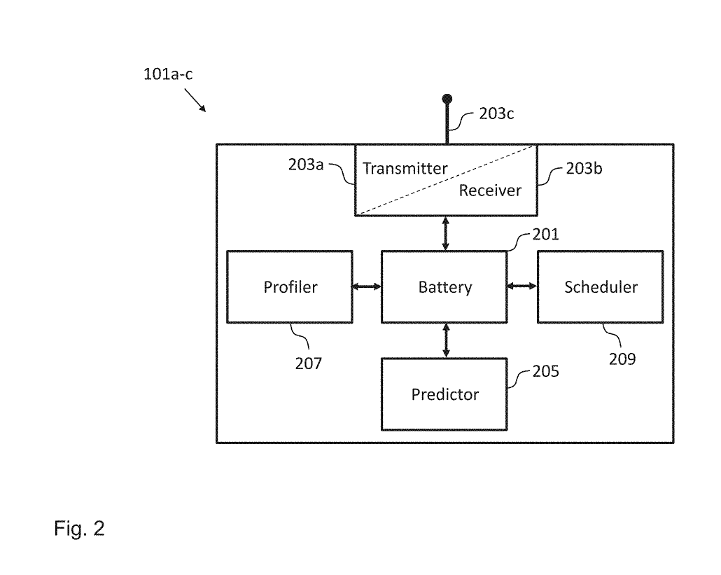

FIG. 1 shows a schematic diagram of an exemplary wireless communication network 100 comprising three exemplary wireless communication devices 101a-c according to an embodiment configured to communicate with an energy distributor 103 in form of a base station according to an embodiment. As will be described in more detail further below, in an alternative embodiment one of the further communication devices 101a-c can assume the role of the energy distributor instead of the base station 103. FIG. 2 shows a more detailed view of one of the exemplary wireless communication devices 101a-c.

The wireless communication device 101a-c comprises a rechargeable energy storage 201 in form of a battery configured to supply the wireless communication device 101a-c with energy to maintain operation of the wireless communication device 101a-c. Moreover, the wireless communication device 101a-c comprises a transmitter 203a configured to transmit an energy status message to the energy distributor in form of the base station 103 and a receiver 203b configured to extract energy from a wireless signal received by the wireless communication device 101a-c from an energy provider and to use the energy extracted from the wireless signal to recharge the rechargeable energy storage 201, wherein the wireless signal is provided by the energy provider in response to the energy status message transmitted to the energy distributor in form of the base station 103.

As indicated in FIG. 2, in an embodiment the transmitter 203a and the receiver 203b of the wireless communication device 101a-c can share at least some components, for instance, an antenna 203c of the wireless communication device 101a-c.

In an embodiment, the energy provider is the base station 103 itself. In such an embodiment the base station 103 can comprise a transmitter configured to provide energy to the wireless communication device 101a-c by means of a wireless signal. Alternatively or additionally, an energy provider can be implemented in form of a dedicated unit in communication with the base station 103 and comprising a transmitter configured to provide energy to the wireless communication device 101a-c by means of a wireless signal.

In an embodiment, the wireless communication device 101a-c further comprises a predictor 205 configured to predict the amount of energy required to maintain operation of the wireless communication device 101a-c until the end of an upcoming time window based on the current level of the rechargeable energy storage 201 and an energy consumption profile of the wireless communication device 101a-c. In an embodiment, the predictor 205 is further configured to predict the end of the upcoming time window on the basis of at least one recharging event of the wireless communication device 101a-c within an elapsed time window.

In an embodiment, the energy status message comprises information about the amount of energy required to maintain operation of the wireless communication device 101a-c until the end of the upcoming time window and/or information about a time interval defining by when the amount of energy required to maintain operation of the wireless communication device 101a-c has to be received by the wireless communication device 101a-c. In an embodiment, the energy status message further comprises information about the current level of the rechargeable energy storage of the wireless communication device, the level of the rechargeable energy storage 201 of the wireless communication device 101a-c at the end of an upcoming time window, the storage capacity of the rechargeable energy storage 201 of the wireless communication device 101a-c and/or a minimum storage level of the rechargeable energy storage 201 required to operate the wireless communication device 101a-c.

In an embodiment, the transmitter 203a of the wireless communication device 101a-c is configured to transmit the energy status message as part of a data message to the energy distributor 103, i.e. as part of a message containing control data and/or payload data to be provided to the energy distributor 103. Alternatively, the energy status message can be a dedicated message.

In an embodiment, the wireless communication device 101a-c further comprises a profiler 207 configured to generate the energy consumption profile of the wireless communication device 101a-c. In an embodiment, the wireless communication device 101a-c is configured to perform a plurality of processes and the profiler 207 is configured to generate the energy consumption profile of the wireless communication device 101a-c on the basis of the frequency, the duration and/or the time correlation of any processes of the plurality of processes performed by the wireless communication device 101a-c within an elapsed time window.

In an embodiment the wireless communication device 101a-c is configured to perform a plurality of processes, wherein the wireless communication device 101a-c further comprises a scheduler 209 for scheduling these processes within the upcoming time window, wherein the predictor 205 is configured to predict the amount of energy required to maintain operation of the wireless communication device 101a-c until the end of the upcoming time window based on the current level of the rechargeable energy storage 201, the energy consumption profile of the wireless communication device 101a-c and the processes scheduled by the scheduler 209 in the upcoming time window.

In an embodiment, the wireless communication device 101a-c is further configured to request and obtain energy in the context of an incentive scheme. For instance, the wireless communication device 101a-c could be configured to perform an energy consuming process that involves a further wireless communication device 101a-c, such as sharing a file with a further wireless communication device, in return for energy provided by the energy provider.

As described above, in an embodiment the predictor 205 configured to predict the amount of energy required to maintain operation of the wireless communication device 101a-c until the end of an upcoming time window based on the current level of the rechargeable energy storage 201 and an energy consumption profile of the wireless communication device 101a-c is part of the wireless communication device 101a-c. Alternatively or additionally, the predictor configured to predict the amount of energy required to maintain operation of the wireless communication device 101a-c until the end of the upcoming time window based on the current level of the rechargeable energy storage 201 and the energy consumption profile of the wireless communication device 101a-c can be implemented as part of the energy distributor, in particular the base station 103.

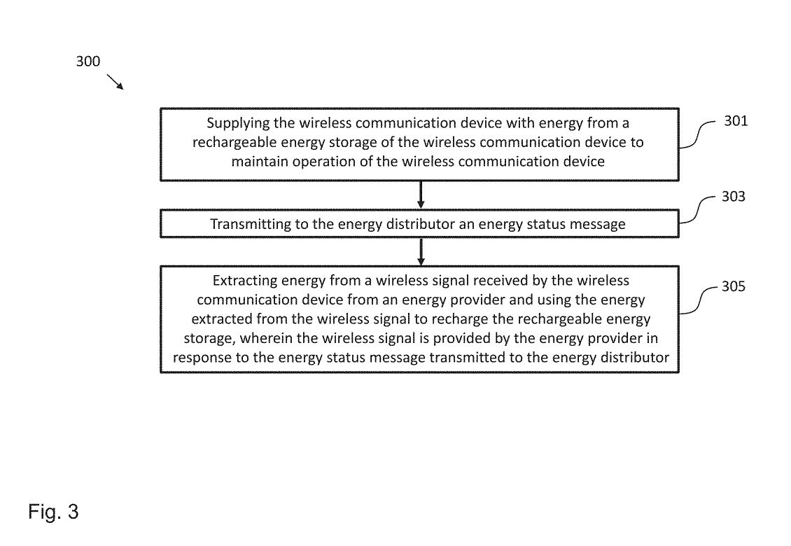

FIG. 3 shows a schematic diagram of a method 300 of operating a wireless communication device 101a-c according to an embodiment. The method 300 comprises the following steps.

In a step 301 the wireless communication device 101a-c is continuously supplied with energy from the rechargeable energy storage 201 of the wireless communication device 101a-c to maintain operation of the wireless communication device 101a-c.

In a step 303 an energy status message is transmitted to the energy distributor, in particular the base station 103.

In a step 305 energy is extracted from a wireless signal received by the wireless communication device 101a-c from the energy provider and the energy extracted from the wireless signal is used to recharge the rechargeable energy storage 201 of the wireless communication device 101a-c, wherein the wireless signal is provided by the energy provider in response to the energy status message transmitted to the energy distributor, in particular the base station 103.

In the following, further implementation forms, embodiments and aspects of the wireless communication device 101a-c, the base station 103 and the method 300 are described.

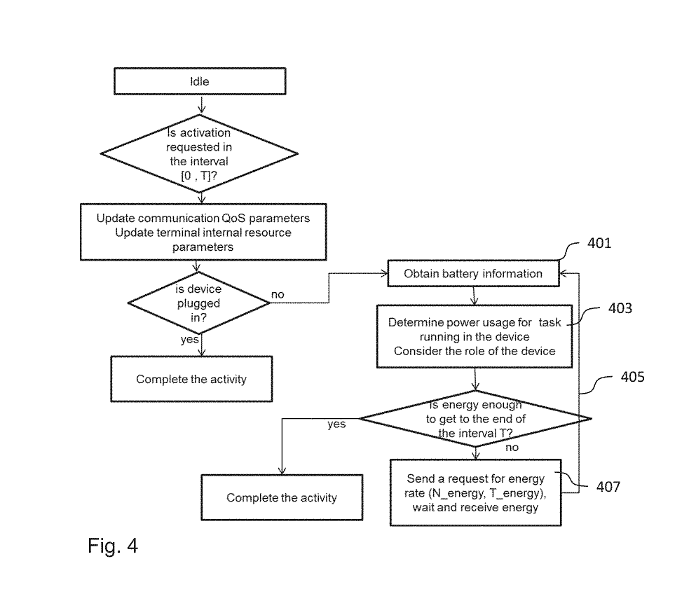

FIG. 4 shows a flow chart illustrating the operation of a wireless communication device 101a-c according to an embodiment, where the predictor 205 is implemented as part of the wireless communication device 101a-c, i.e. all the information about the activities scheduled and those predicted in the upcoming time window, as well as the prediction of the next plug-in (recharging) opportunity is processed at the wireless communication device 101a-c.

More specifically, in a step 401 the wireless communication device 101a-c obtains information about the current level of its rechargeable battery 201. In steps 403 and 405 the predictor 205 predicts the amount of energy required to maintain operation of the wireless communication device 101a-c until the end of an upcoming time window T based on the current level of the rechargeable battery 201 and checks whether the current level of the rechargeable battery 201 is sufficient. If this is not the case, the wireless communication device 101a-c sends in step 407 of FIG. 4 an energy status message to the base station 103 in order to request energy from the base station 103 (or an energy provider).

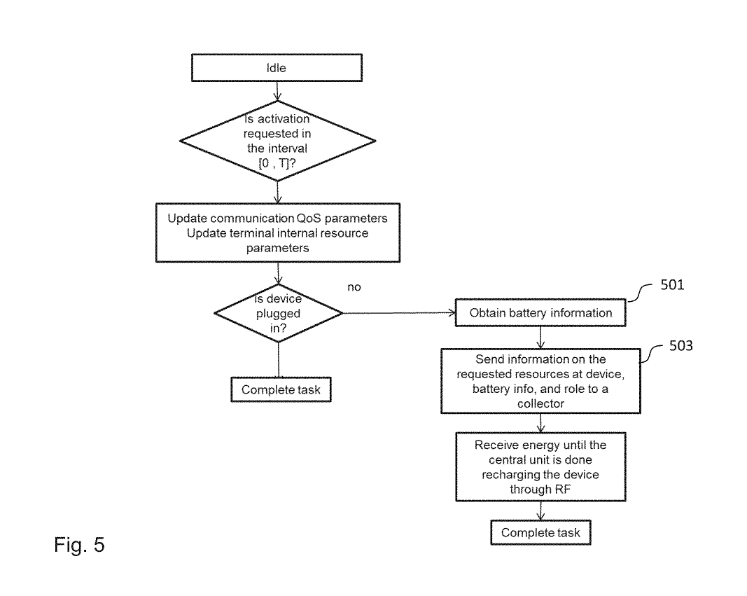

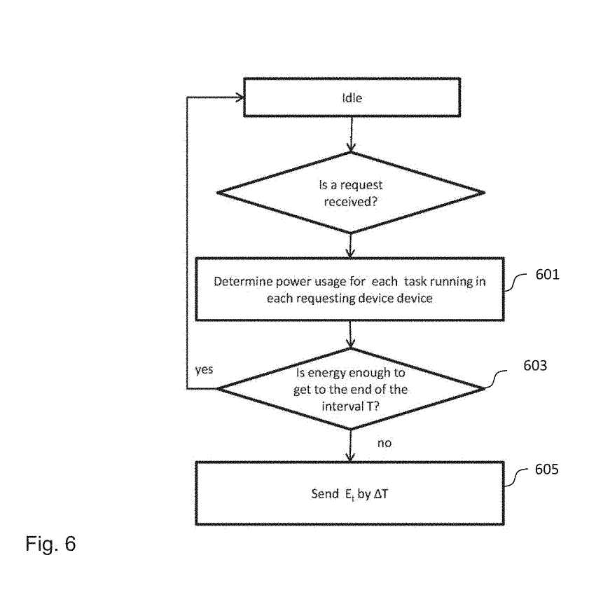

FIG. 5 shows a flow chart illustrating the operation of a wireless communication device 101a-c according to an embodiment and FIG. 6 shows a corresponding flow chart illustrating the operation of an energy distributor in form of a base station 103 according to an embodiment for the case that the predictor is implemented on the side of network, in particular the base station 103.

In a step 501 of FIG. 5 (similar to step 401 of FIG. 4) the wireless communication device 101a-c obtains information about the current level of its rechargeable battery 201. In a step 503 of FIG. 5 the wireless communication device 101 sends an energy status message to the base station 103 containing information about the current level of the rechargeable battery 201 of the wireless communication device 101a-c. In steps 601 and 603 of FIG. 6 (similar to steps 403 and 405 in FIG. 4) the predictor implemented on the base station 103 predicts the amount of energy required to maintain operation of the wireless communication device 101a-c until the end of an upcoming time window T based on the current level of the rechargeable battery 201 of the wireless communication device 101a-c and checks whether the current level of the rechargeable battery 201 is sufficient. If this is not the case, the base station 103 triggers in step 605 of FIG. 6 the provision of a required energy amount E within an upcoming time window T to the wireless communication device 101a-c, wherein the energy is provided by means of a wireless signal emitted by the base station 103 itself or a dedicated energy provider in communication with the base station 103.

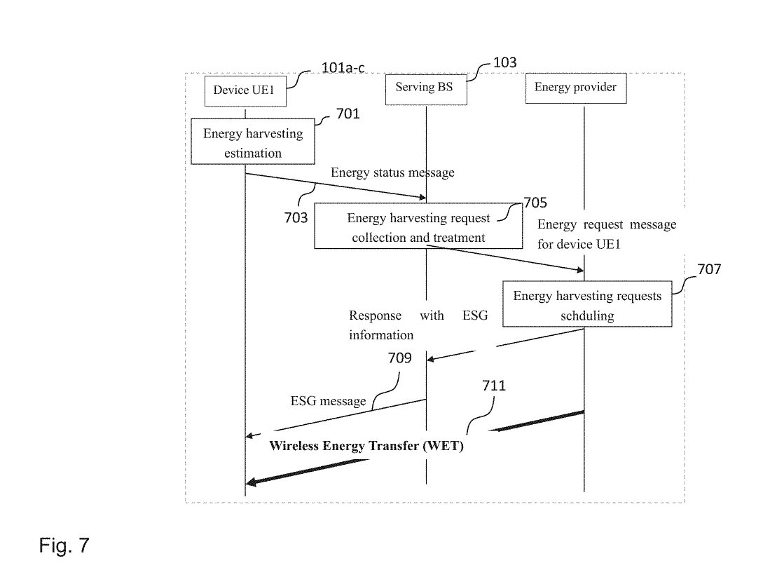

FIG. 7 shows a signaling diagram illustrating the signaling between a wireless communication device 101a-c, an energy distributor in form of a base station 103 and a dedicated energy provider according to an embodiment.

In a step 701 the predictor 205 predicts the amount of energy required to maintain operation of the wireless communication device 101a-c until the end of an upcoming time window based on the current level of the rechargeable battery 201 and checks whether the current level of the rechargeable battery 201 is sufficient. In a step 703 the wireless communication device 101 sends an energy status message to the base station 103 in order to request from the base station energy to be provided by the energy provider. As already described above, the energy status message could include information, such as the current battery status comprising state-of-charge (SoC) of the battery 201 as well as the storage capacity of the battery 201, minimum charge level necessary for the wireless communication device 101a-c to operate, the requested energy to harvest, corresponding timeline and the like. In an embodiment, the energy level information could be provided using a quantized state that corresponds to potential categories (e.g. window of energy demand and a three level timeline, such as “vital”, “urgent” and “normal”). Such a quantification allows to decrease the number of bits necessary for the transmission of this information. In an embodiment, the Physical Downlink Control Channel (PDCCH) (as defined in the LTE standard) is used to transport the energy status message.

Once the base station 103 has received the energy status message from the wireless communication device 101a-c, it handles this request in a step 705. As in the embodiment shown in FIG. 7 the energy is provided to the wireless communication device 101a-c by a dedicated energy provider, the base station 103 is configured to forward the energy status message/request to the energy provider. In step 707 of FIG. 7 the energy provider processes the request and informs the base station 103 about when the energy will be provided to the wireless communication device 101a-c by means of an energy scheduling grant (ESG). The base station 103 forwards this ESG to the wireless communication device 101a-c in step 709 of FIG. 7. In step 711 the energy provider provides the energy to the wireless communication device 101a-c as specified in the ESG. The ESG could be based on a conventional scheduling procedure (e.g. scheduling grants sent in LTE) complemented by a new field indicating energy harvesting instead of useful data.

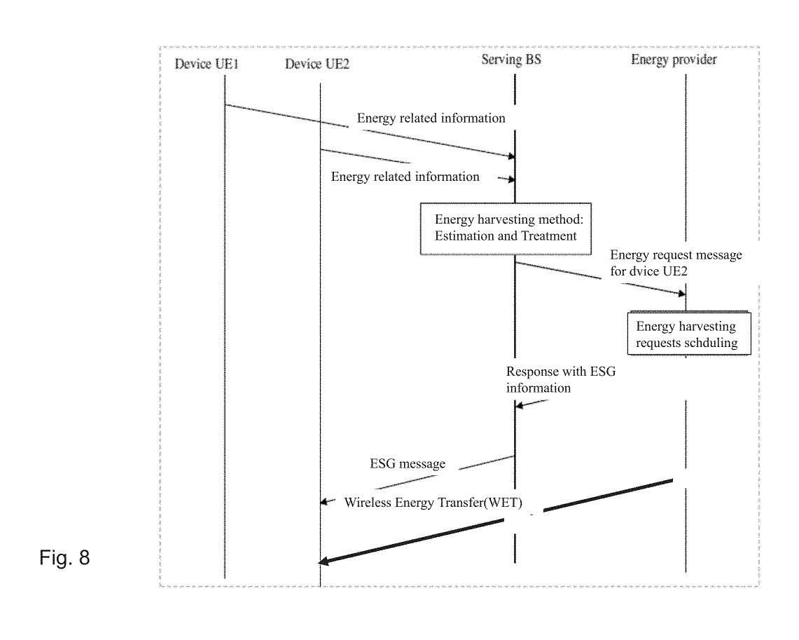

FIG. 8 shows a signaling diagram illustrating the signaling between a wireless communication device 101a-c, an energy distributor in form of a base station 103 and a dedicated energy provider according to an embodiment for the case that the predictor is implemented on the side of the network, i.e. the base station 103. As can be taken from FIG. 8, in this case the base station 103 and the energy provider are configured to handle and schedule energy status messages from several wireless communication devices 101a-c.

The devices described herein may be implemented as optical circuit within a chip or an integrated circuit or an application specific integrated circuit (ASIC). The invention can be implemented in digital and/or analogue electronic and optical circuitry.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the present invention has been described with reference to one or more particular embodiments, those skilled in the art recognize that many changes may be made thereto without departing from the scope of the present invention. It is therefore to be understood that within the scope of the appended claims and their equivalents, the invention may be practiced otherwise than as specifically described herein.

1. A wireless communication device configured to communicate with an energy distributor, the wireless communication device comprising:
a rechargeable energy storage configured to supply the wireless communication device with energy to maintain operation of the wireless communication device;
a transmitter configured to transmit an energy status message to the energy distributor; and
a receiver configured to:
extract energy from a wireless signal received by the wireless communication device from an energy provider, wherein the wireless signal is provided by the energy provider in response to the energy status message transmitted to the energy distributor; and
recharge the rechargeable energy storage using the energy extracted from the wireless signal.

2. The wireless communication device of claim 1, wherein the wireless communication device further comprises a predictor configured to predict the amount of energy required to maintain operation of the wireless communication device until an end of an upcoming time window based on a current level of the rechargeable energy storage and an energy consumption profile of the wireless communication device.

3. The wireless communication device of claim 2, wherein the wireless communication device further comprises a profiler configured to generate the energy consumption profile of the wireless communication device.

4. The wireless communication device of claim 3, wherein the wireless communication device is configured to perform a plurality of processes, and wherein the profiler is configured to generate the energy consumption profile of the wireless communication device on the basis of at least one of the frequency, the duration, and the time correlation of the processes of the plurality of processes performed by the wireless communication device within an elapsed time window.

5. The wireless communication device of claim 2, wherein the wireless communication device is configured to perform a plurality of processes and wherein the wireless communication device further comprises a scheduler configured to schedule processes of the plurality of processes in the upcoming time window, wherein the predictor is configured to predict the amount of energy required to maintain operation of the wireless communication device until the end of the upcoming time window based on the current level of the rechargeable energy storage, the energy consumption profile of the wireless communication device and the scheduled processes in the upcoming time window.

6. The wireless communication device of claim 2, wherein the predictor is further configured to predict the end of the upcoming time window on the basis of at least one recharging event within an elapsed time window.

7. The wireless communication device of claim 1, wherein the energy status message comprises at least one of:
information about the amount of energy required to maintain operation of the wireless communication device until an end of an upcoming time window; and
information about a time interval defining by when the amount of energy required to maintain operation of the wireless communication device has to be received by the wireless communication device.

8. The wireless communication device of claim 1, wherein the transmitter is configured to transmit the energy status message as part of a data message to the energy distributor.

9. The wireless communication device of claim 1, wherein the wireless communication device is further configured to perform an energy consuming process involving a different wireless communication device in return for energy provided by the energy provider.

10. The wireless communication device of claim 1, wherein the energy status message comprises at least one of:
information about a current level of the rechargeable energy storage of the wireless communication device;
information about a level of the rechargeable energy storage of the wireless communication device at the end of an upcoming time window;
information about a storage capacity of the rechargeable energy storage of the wireless communication device; and
a minimum storage level of the rechargeable energy storage required to operate the wireless communication device.

11. An energy distributor configured to communicate with a wireless communication device, the energy distributor comprising:
a receiver configured to receive from the wireless communication device an energy status message,
wherein the energy distributor is further configured to trigger an energy provider to provide energy to the wireless communication device using a wireless signal in response to the energy status message.

12. The energy distributor of claim 11, wherein the energy status message comprises information about a current level of a rechargeable energy storage of the wireless communication device and wherein the energy distributor further comprises a predictor configured to predict the amount of energy required to maintain operation of the wireless communication device until the end of an upcoming time window based on a current level of the rechargeable energy storage and an energy consumption profile of the wireless communication device.

13. The energy distributor of claim 11, wherein the energy provider is a transmitter of the energy distributor, and wherein the transmitter of the energy distributor is configured to provide energy to the wireless communication device using the wireless signal.

14. A method of operating a wireless communication device configured to communicate with an energy distributor, the method comprising:
supplying the wireless communication device with energy from a rechargeable energy storage of the wireless communication device to maintain operation of the wireless communication device;
transmitting an energy status message to the energy distributor; and
extracting energy from a wireless signal received by the wireless communication device from an energy provider, wherein the wireless signal is provided by the energy provider in response to the energy status message transmitted to the energy distributor; and
recharging the rechargeable energy storage using the energy extracted from the wireless signal.
